(19) United States
(12) Patent Application Publication
(10) Pub. No.: US 2024/0202551 A1
(43) Pub. Date: Jun. 20, 2024

(54) Visual Question Answering for Discrete Document Field Extraction

(71) Applicant: INTUIT INC., Mountain View, CA (US)

(72) Inventors: Nikash WALIA, San Jose, CA (US); Conrad DE PEUTER, Mountain View, CA (US)

(21) Appl. No.: 18/067,461

(22) Filed: Dec. 16, 2022

(51) Int. Cl. G06N 5/04; G06N 20/00

(52) U.S. Cl. CPC G06N 5/04; G06N 20/00

(57) ABSTRACT

Certain aspects of the present disclosure provide techniques for training and using visual question answering (VQA) machine learning models. Embodiments include determining a question related to an image. Embodiments include providing one or more inputs to a VQA machine learning model based on the image and a set of possible answers associated with the question, wherein the VQA machine learning model analyzes a data set comprising text of the set of possible answers together with text data extracted from the image. Embodiments include receiving, from the VQA machine learning model in response to the one or more inputs, one or more outputs indicating an answer of the set of possible answers. Embodiments include performing one or more actions within a software application based on the answer indicated in the one or more outputs.

### INTRODUCTION

Aspects of the present disclosure generally relate to data extraction in software applications, and more specifically to using a visual question answering machine learning model trained based on augmented image data to answer questions that are not innately represented by text in images.

### BACKGROUND

Documents and forms may be used to record or reflect information or data about a person, business, event, or other matter. The document may contain fields for specific types of information. In some cases, users seek to digitize documents to make them more searchable, usable, or accessible. In many instances, this is done by uploading a photo of the document, and then utilizing a software application in order to extract the information from the document (e.g., via optical character recognition (OCR) techniques and/or machine learning models). However, while some information included in images of documents is present as text (e.g., in particular fields), other information included in images of documents is not present as text. For example, checkboxes may convey non-textual information. In another example, the quality of an image of a document may be evident based on characteristics of the image (e.g., lighting, resolution, blur, and the like) but is not included as text in the image.

Certain existing techniques involve the use of machine learning models that are trained to extract particular types of information, including non-textual information, from images of documents. However, because many machine learning models may be trained, deployed, and maintained, significant amounts of computing resources may be expended in training, deploying, and maintaining these machine learning models. For example, training and utilizing separate machine learning models for extracting each of a plurality of different types of information from an image of a document (e.g., using one or more machine learning models for extracting non-textual information and one or more other machine learning models for extracting textual information) may involve expending a considerable amount of computing resources.

Accordingly, improved techniques are needed to extract data from images of documents for use in a workflow of a software application.

### BRIEF SUMMARY

Certain embodiments provide a computer-implemented method for automated data extraction. An example method generally includes: determining a question related to an image; providing one or more inputs to a visual question answering (VQA) machine learning model based on the image and a set of possible answers associated with the question, wherein the VQA machine learning model analyzes a data set comprising text of the set of possible answers together with text data extracted from the image; receiving, from the VQA machine learning model in response to the one or more inputs, one or more outputs indicating an answer of the set of possible answers; and performing one or more actions within a software application based on the answer indicated in the one or more outputs.

Other embodiments provide a computer-implemented method for training a machine learning model. An example method generally includes: determining a set of possible answers to a question related to a plurality of images; generating a training data set comprising: training inputs that are based on the plurality of images and the set of possible answers; and training outputs that are based on known answers to the question for the plurality of images; and providing the training inputs to a visual question answering (VQA) machine learning model, wherein the VQA machine learning model analyzes, for each respective image of the plurality of images, a respective data set comprising text of the set of possible answers together with text data and positional data extracted from the respective image; receiving outputs from the VQA machine learning model in response to the training inputs; comparing the outputs to the training outputs; and adjusting one or more parameters of the VQA machine learning model based on the comparing.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is an illustration of an example related to automated data extraction using a visual question answering (VQA) model, according to embodiments of the present disclosure.

FIG. 2 is an illustration of another example related to automated data extraction using a visual question answering (VQA) model, according to embodiments of the present disclosure.

FIG. 3 illustrates example operations for automated data extraction, according to embodiments of the present disclosure.

FIG. 4 illustrates example operations for training a machine learning model for automated data extraction, according to embodiments of the present disclosure.

FIG. 5 illustrates an example computing system with which embodiments of the present disclosure may be implemented.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training and using a visual question answering (VQA) model to extract data from a document, including non-textual data.

Digital images of documents may be used to provide data to a workflow of a software application for processing. These images generally include textual information (e.g., included in particular fields of the documents) as well as non-textual information. Because of the variety of documents that may be used to complete a workflow and the variety of formats in which any specific document may be formatted, many machine learning models are generally used to extract data from these documents. However, maintaining many machine learning models to extract data from a universe of documents may be a computationally and operationally expensive task, and may also require significant memory storage space, which may make it infeasible to leverage such models on many types of devices, such as mobile devices or other computing devices with limited computational resources.

In some cases, a visual question answering (VQA) model is used to extract data from an image of a document. However, existing VQA model techniques for document data extraction only allow for extraction of textual data from a document, as these existing models are trained to output an indication of particular text in an image that is likely to contain an answer to a given question. For example, existing VQA models for document data extraction are trained to analyze text extracted from an image of a document and output likelihoods of different textual elements extracted from the document being the answer to a given question. Such VQA models may be characterized as highlighter models, as the output from the models may be used to highlight particular text in images of documents that is likely to include the answer to a given question. For instance, if the question is “what are wages?” then a VQA model may be trained to output an indication of text in the document (e.g., a W2 form) that is most likely to be an amount of wages so that the indicated text can be highlighted.

Existing “highlighter” type VQA model techniques cannot be used to extract non-textual information from an image of a document, and so these models are often used in conjunction with different types of machine learning models that can be used to extract non-textual information from images of documents. Thus, in existing systems that utilize VQA models for extracting textual data from images of documents, separate models must be used for extracting non-textual data, thus resulting in additional utilization of computational resources for training, deployment, and use of such models.

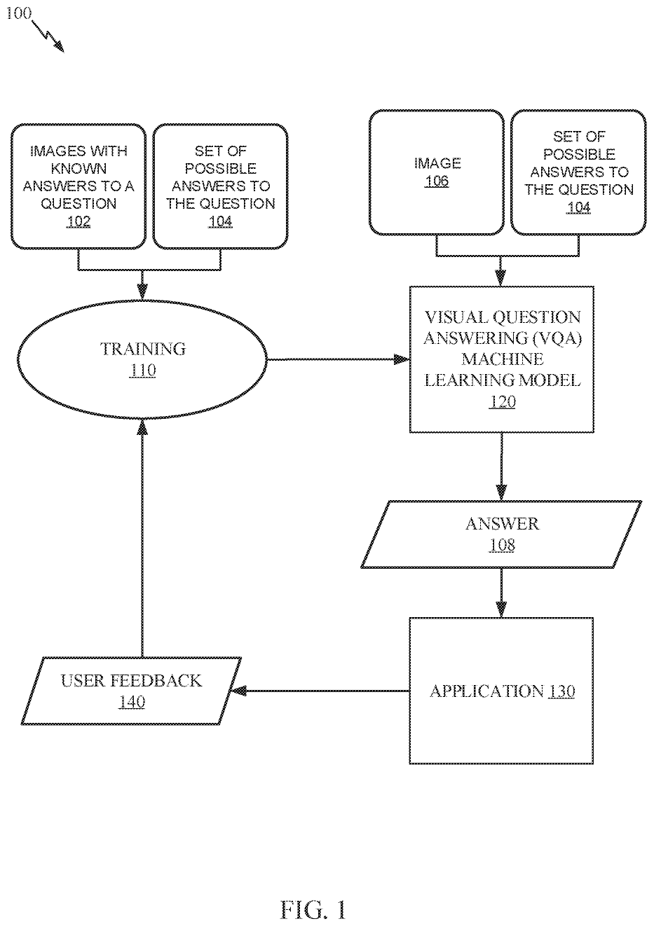

Embodiments presented herein provide techniques for training and using a “highlighter” type VQA model to extract non-textual information from images of documents. As discussed in more detail below with respect to FIGS. 1-3, text representing a set of possible answers to a question is injected into the text data (e.g., otherwise including text extracted from an image of a document) analyzed by the VQA model, first during training and then when using the trained model on new images. Thus, the set of possible answers to the question, which may otherwise not be present as text in the image, become part of the text analyzed by the VQA model. For example, if the question is “does Box 12 contain text?” and the set of possible answers includes “yes” and “no” (e.g., which would not be present as text in the image of the document), then the text “yes no” may be injected into the text data analyzed by the VQA model, which otherwise includes text that is extracted from the image. The VQA model may then output an indication of whether the answer to the question is “yes” or “no”, such as by outputting probabilities for each text element in the text data analyzed by the VQA model. If the probability output by the VQA model for “yes” is higher than the probability it outputs for “no”, or meets some other condition such as exceeding a threshold, then this may be an indication that the answer to the question is “yes” (e.g., Box 12 does contain text in the image of the document). For example, the output from the model may indicate that “yes” should be highlighted.

Techniques describe herein constitute a technical improvement with respect to existing techniques for automated data extraction from images of documents. For example, by injecting text of possible answers to a given question into text data that otherwise includes text extracted from images of documents (which do not include the text of the possible answers) during training of a VQA model and when using the trained VQA model, embodiments of the present disclosure allow a VQA model to be used to extract non-textual data from images of documents. Thus, while existing VQA models can only be used to answer questions when the possible answers are included as text in an image, techniques described herein allow VQA models to be used to answer questions even when the possible answers are not included as text in an image. Accordingly, the technical solution described herein allows a VQA model to do something that was not possible in prior technical implementations. Furthermore, the ability to use a VQA model to extract both textual and non-textual data from an image of a document allows a single VQA model to be used for both purposes, thus avoiding the significant amount of computing resource utilization that would otherwise be required to train, deploy, and use separate machine learning models for extracting different types of data from images of documents.

Using a VQA model to extract non-textual data from an image as described herein may have a higher level of accuracy than using a different type of machine learning model for such extraction, as the VQA model is also able to analyze the image itself and/or positional information from the image, thereby allowing visual elements to inform the model's outputs. Techniques described herein enable a wider variety of information to be captured regarding documents based on images of the documents, leveraging visual information in addition to raw text, and provide a document-agnostic solution that can be generalized to any form of discrete information with a limited set of potential options (e.g., questions for which a set of possible answers can be determined in text form).

### Training and Using a Visual Question Answering Model to Extract Non-Textual Data from Images of Documents

FIG. 1 is an illustration 100 of an example related to automated data extraction using a visual question answering (VQA) model, according to embodiments of the present disclosure.

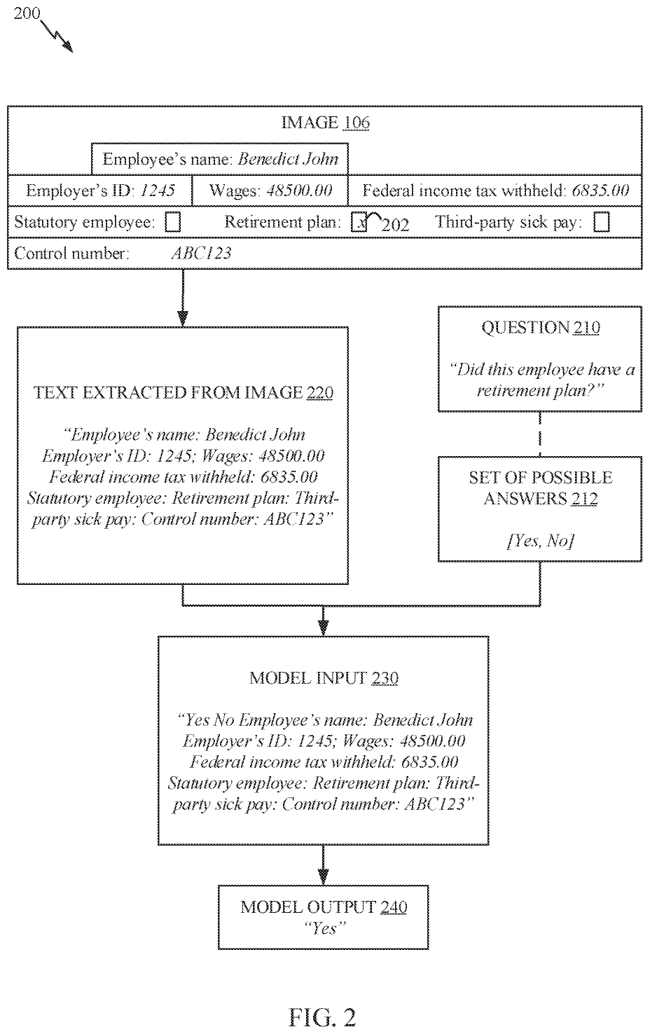

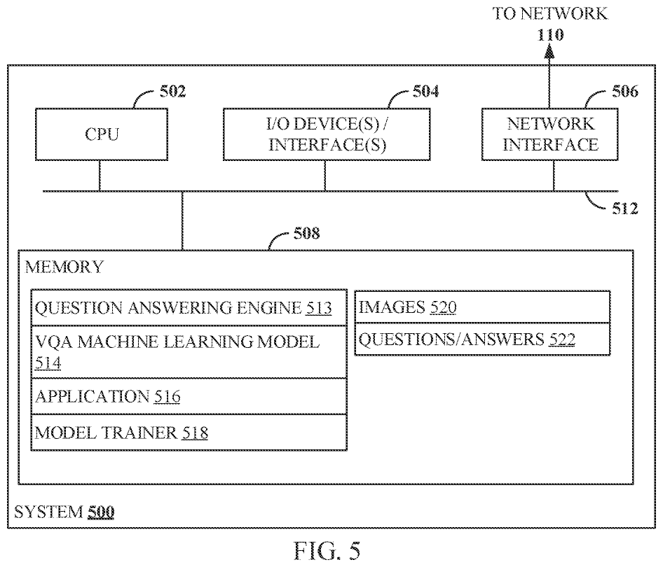

A machine learning model trainer, which may be a software component running on a computing device such as system 500 of FIG. 5, described below, generally generates a training data set based on electronic images of documents and trains machine learning models to answer questions about images of documents. To generate a training data set, the machine learning model trainer may, in some aspects, retrieve a data set from a data repository including a plurality of images 102 with known answers to a question (e.g., based on input from one or more users) as well as a set of possible answers 104 to the question. Images 102 generally represent images of documents to which the question relates. For example, as described in more detail below with respect to FIG. 2, images 102 may be images of W2 forms with known answers to the question “did this employee have a retirement plan?” and images 102 themselves may not contain text of the possible answers to the question (e.g., yes and no or true and false). For example, the question may relate to a checkbox that is either checked or unchecked in the images. Set of possible answers 104 to the question may include, for example “yes” and “no” or “true” and “false”. Each training data instance in the training data may include training inputs comprising a set of text extracted from a particular image 102, with the set of possible answers 104 injected into the text as described below with respect to FIG. 2, associated with a training output comprising a label indicating a known answer to the question for the particular image 102. Training inputs may further include the images themselves and, in some embodiments, positional data extracted from the images. For example, positional data may include layout information such as bounding boxes and other structural document elements.

Training 110 generally involves a supervised learning process in which training inputs are provided to VQA model 120 and outputs received from VQA model 120 in response to the training inputs are compared to the training outputs. Parameters of VQA model 120 are iteratively adjusted based on comparing the model's outputs to the training outputs, such as to optimize a cost function.

In an example, VQA model 120 is a neural network, such as a convolutional neural network (CNN). Neural networks generally include a collection of connected units or nodes called artificial neurons. A CNN is a type of neural network that was inspired by biological processes in that the connectivity pattern between neurons resembles the organization of a visual cortex, and CNNs are often used for image-based processing. The operation of neural networks can be modeled as an iterative process. Each node has a particular value associated with it. In each iteration, each node updates its value based upon the values of the other nodes, the update operation typically consisting of a matrix-vector multiplication. The update algorithm reflects the influences on each node of the other nodes in the network. In another example, VQA model 120 is a transformer model. A transformer model is a deep learning model that adopts the mechanism of self-attention, differentially weighting the significance of each part of the input data.

When provided with training inputs, VQA model 120 processes the training inputs and outputs an indication of which text element represented in the training inputs is likely to be the answer to a particular question. Outputs from VQA model 120 may, in some embodiments, be in the form of probabilities with respect to each text element (e.g., word, phrase, sentence, string, n-gram, and/or the like) included in the inputs, where each probability indicates a likelihood that a given text element is the answer to the question. The outputs from VQA model 120 are compared to the known labels associated with the training inputs (e.g., the training outputs) to determine the accuracy of VQA model 120, and VQA model 120 is iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the answers produced by the machine learning model based on the training inputs match the known answers associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for VQA model 120, such as based on validation data and test data, as is known in the art.

Once trained, VQA model 120 may be used to answer the question with respect to an image 106 for which the answer is not known. For example, just as during training 110, the set of possible answers 104 to the question may be injected into the text data that otherwise contains text extracted from image 106, and VQA model 120 may output an indication of an answer 108 based on the text data. Inputs provided to VQA model 120 may further include the image 106 itself and, in some embodiments, positional data extracted from image 106. In an example, answer 108 is indicated in the form of probabilities output by VQA model 120 for each text element in the inputs provided to VQA model 120 (e.g., the text of the set of possible answers 104 to the question and the text extracted from image 106), and answer 108 may correspond to the text element with a highest probability, with a probability above a threshold, and/or meeting some other condition.

Answer 108 may be used by an application 130 as part of a workflow. For example, application 130 may extract data from images of documents through the use of VQA model 120 (e.g., by asking questions with respect to the images using VQA model 120), and may perform further processing on the extracted data. In one example, application 130 is a financial management application such as a tax preparation application and allows users to import data via images of documents for use in populating tax forms. Application 130 may, for example, populate a component of a tax form based on answer 108 (e.g., which may indicate, for example, that image 106 indicates that a user did or did not have a retirement account). Application 130 may utilize VQA model 120 to extract a variety of different types of data from images, such as including answers that are included as text in the images as well as answers that are not included as text in the images.

In some cases user feedback 140 is received with respect to answer 108. For example, a user of application 130 may provide input indicating that answer 108 is correct or incorrect (e.g., the user may edit a value automatically imported from image 106 to a different value or otherwise indicate that answer 108 is not accurate). User feedback 140 may then be used to re-train VQA model 120 for improved accuracy. For example, a new training data instance may be generated based on image 106 and the set of possible answers 104 with a label that is based on user feedback 140 (e.g., either indicating answer 108 or a different answer that is indicated by user feedback 140). Training 110 may then be performed again (e.g., at regular intervals, when a threshold number of new training data instances are available, or when some other condition is met) to produce an updated VQA model 120. The re-trained VQA model 120 may have improved accuracy as a result of the re-training, such as providing more accurate answers in response to inputs based on images.

While certain embodiments are described herein with respect to particular types of VQA models (e.g., CNNs, transformers, and the like), documents, questions, answers, applications, and the like, these are included as examples, and other types of VQA models, documents, questions, answers, applications, and the like may alternatively or additionally be used with techniques described herein.

FIG. 2 is an illustration 200 of another example related to automated data extraction using a visual question answering (VQA) model, according to embodiments of the present disclosure. Illustration 200 includes an example of image 106 of FIG. 1.

Image 106 represents an image of a W2 form, which is included as an example of a type of document that can be captured in an image. Image 106 includes textual data such as an employee's name, an employer's identification number, an amount of wages, an amount of federal income tax withheld, and a control number, as well non-textual data such as checkboxes indicating whether the employee is a statutory employee, whether the employee has a retirement plan, and whether third-party sick pay was received. For example, checkbox 202 is checked indicating that the employee has a retirement plan. Image 106 may include other types of non-textual data, such as color, lighting, resolution, formatting, and other types of data.

Text 220 is extracted from image 106, such as using optical character recognition (OCR) or other text extraction techniques, and includes all text content from image 106. In particular, text 220 includes the following text: “Employee's name: Benedict John Employer's ID: 1245; Wages: 48500.00 Federal income tax withheld: 6835.00 Statutory employee: Retirement plan: Third-party sick pay: Control number: ABC123”. In some embodiments, positional data is also extracted from image 106, such as indicating where each extracted text element is located with respect to other extracted text elements. In some examples, positional information includes layout information indicating a layout of the document depicted in the image.

A question 210 that a VQA model is trained to answer, as described above with respect to FIG. 1, is “did this employee have a retirement plan?” For example, question 210 may relate to checkbox 202 from a type of document that is depicted in image 106. The set of possible answers 212 to the question includes “yes” and “no”, neither of which is included as text in image 106. Question 210 and the set of possible answers 212 are included as an example, and other types of questions and possible answers may also be used. Another example of a question is “how bright is the lighting in the image?” for which the possible answers could be, for example, “low”, “medium”, and “high”. For instance, questions relating to image quality may be helpful in determining whether to prompt a user to capture a new image of a document. As another example, a question could be “what color is the background of the image” for which the possible answers could include a variety of different colors, or a question could be “how many fields are there in the document?” for which the possible answers could include a range of numbers.

Model input 230 is generated by injecting the text of the set possible answers 212 into the text 220 extracted from image 106. The text of the set of possible answers could potentially be injected into the text extracted from the image at any position (e.g., before, after, or somewhere in the midst of the extracted text), but in the example shown the possible answers are injected at the beginning of the extracted text. Thus, model input 230 includes the following text: “Yes No Employee's name: Benedict John Employer's ID: 1245; Wages: 48500.00 Federal income tax withheld: 6835.00 Statutory employee: Retirement plan: Third-party sick pay: Control number: ABC123”. In some embodiments, positional information is also included in model input 230, such as indicating where each text element is positioned in the document relative to other text elements. Positional information may include layout information, such as including positions of bounding boxes and other structural elements in documents. In some cases, model input 230 further includes image 106 itself.

Model input 230 may be analyzed by a VQA model, such as VQA model 120 of FIG. 1, and the VQA model may output an indication of an answer to the question based on model input 230. For example, model output 240 indicates that the answer to the question “did this employee have a retirement plan?” is “yes”. Model output 240 may, for example, be in the form of probabilities with respect to each text element in model input 230, where each probability indicates a likelihood that a given text element (e.g., “Yes”, “No”, “Employee's name:” “Benedict John”, etc.) is the answer to the question. In a particular example, a probability output by the VQA model for the text element “Yes” is a highest probability output for any text element, exceeds a threshold, or meets some condition indicating that the text element “Yes” is the answer to the question. In an embodiment, model output 240 indicates that “Yes” should be highlighted, although highlighting may not necessarily be performed.

In some embodiments, the VQA model analyzes model input 230, including the text of the set of possible answers and the text (and, in some embodiments, positional information) extracted from image 106, in a single forward pass. Thus, the text of the set of possible answers is analyzed by the VQA model in the way that such a VQA model would ordinarily analyze text extracted from an image, and along with such text.

### Example Method for Automated Extraction of Data from an Image of a Document

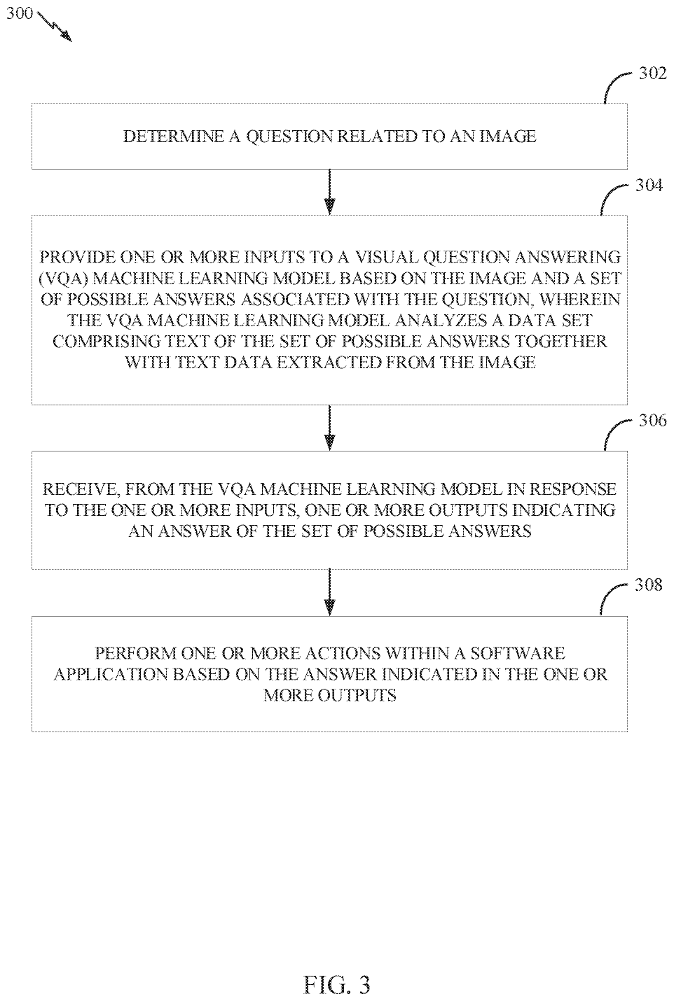

FIG. 3 illustrates example operations 300 for automated data extraction. Operations 200 may be performed by software application, such as application 130 of FIG. 1 and/or application 516 and/or question answering engine 513 of FIG. 5, which runs on a computing device such as system 500 of FIG. 5.

As illustrated, operations 300 begin at step 302 with determining a question related to an image.

Operations 300 continue at step 304, with providing one or more inputs to a visual question answering (VQA) machine learning model based on the image and a set of possible answers associated with the question, wherein the VQA machine learning model analyzes a data set comprising text of the set of possible answers together with text data extracted from the image. In some embodiments, the text of the set of possible answers and the text data (and, in some embodiments, positional data) extracted from the image are analyzed by the VQA machine learning model in a single forward pass. The image itself may also be analyzed by the VQA machine learning model, such as in the same forward pass. The set of possible answers may, in some embodiments, not be present in text form in the image. In one particular example, the set of possible answers comprises true and false or yes and no.

Operations 300 continue at step 306, with receiving, from the VQA machine learning model in response to the one or more inputs, one or more outputs indicating an answer of the set of possible answers.

Operations 300 continue at step 308, with performing one or more actions within a software application based on the answer indicated in the one or more outputs. In some embodiments, performing the one or more actions within the software application based on the answer indicated in the one or more outputs comprises assigning a value to a variable in the software application based on the answer. In certain embodiments, performing the one or more actions within the software application based on the answer indicated in the one or more outputs comprises displaying the answer to a user via a user interface.

Certain embodiments further comprise determining a different question related to the image, wherein a given answer of a different set of possible answers associated with the different question is present in text form in the image. For example, with reference to FIG. 2, the different question may be “what are wages?” and the given answer may be “48500.00”, which is present in image 106. Embodiments include providing one or more different inputs to the VQA machine learning model based on the image and receiving, from the VQA machine learning model in response to the one or more different inputs, one or more different outputs indicating the given answer of the different set of possible answers.

Notably, operations 300 is just one example with a selection of example steps, but additional methods with more, fewer, and/or different steps are possible based on the disclosure herein.

### Example Method for Training a Machine Learning Model

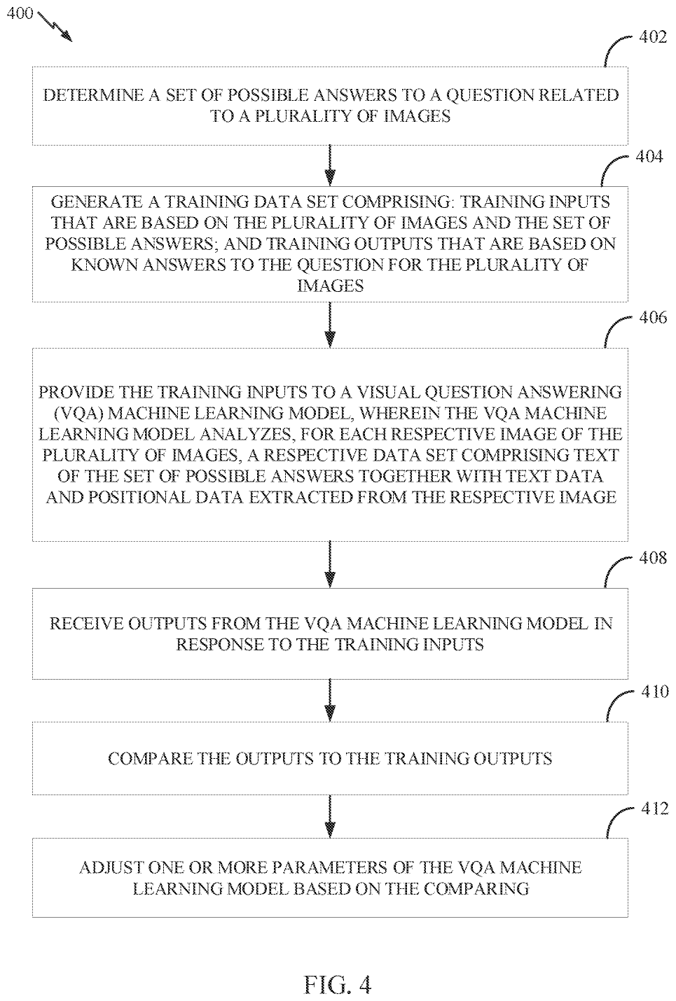

FIG. 4 illustrates example operations 400 for training a machine learning model. Operations 400 may be performed, for example, by a model training component such as model trainer 518 of FIG. 5.

As illustrated, operations 400 begin at step 402 with determining a set of possible answers to a question related to a plurality of images.

Operations 400 continue at step 404, with generating a training data set comprising: training inputs that are based on the plurality of images and the set of possible answers; and training outputs that are based on known answers to the question for the plurality of images.

Operations 400 continue at step 406, with providing the training inputs to a visual question answering (VQA) machine learning model. For example, the VQA machine learning model may analyze, for each respective image of the plurality of images, a respective data set comprising text of the set of possible answers together with text data (and, in some embodiments, positional data) extracted from the respective image.

Operations 400 continue at step 408, with receiving outputs from the VQA machine learning model in response to the training inputs.

Operations 400 continue at step 410, with comparing the outputs to the training outputs.

Operations 400 continue at step 412, with adjusting one or more parameters of the VQA machine learning model based on the comparing.

Notably, operations 400 is just one example with a selection of example steps, but additional methods with more, fewer, and/or different steps are possible based on the disclosure herein.

### Example System for Training and Using VQA Machine Learning Models for Automated Data Extraction

FIG. 5 illustrates an example system 500 that trains and uses VQA machine learning models to automatically extract textual and non-textual data from images of documents as described herein.

As shown, system 500 includes a central processing unit (CPU) 502, one or more I/O device interfaces 504 that may allow for the connection of various I/O devices 514 (e.g., keyboards, displays, mouse devices, pen input, etc.) to the system 400, network interface 506 through which system 500 is connected to network 590 (which may be a local network, an intranet, the internet, or any other group of computing devices communicatively connected to each other), a memory 508, and an interconnect 512.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508.

CPU 502 is included to be representative of a single CPU, multiple CPUs, a single CPU having multiple processing cores, and the like.

Memory 508 is representative of a volatile memory, such as a random access memory, or a nonvolatile memory, such as nonvolatile random access memory, phase change random access memory, or the like. As shown, memory 508 includes a region identification module 520, a key and value identification module 530, key-value set generator 540, application 550, model trainer 560, and training data set repository 570.

Memory 508 comprises a question answering engine 513, which may utilize a VQA model such as VQA machine learning model 514 to determine answers to questions about images. For example, question answering engine 513 may perform operations 300 of FIG. 3. Memory 508 further comprises VQA machine learning model 413 and application 516, which may correspond to VQA machine learning model 120 and application 130 of FIG. 1. Memory 508 further comprises model trainer 518, which generally performs operations related to training VQA machine learning model 514, such as training 110 of FIG. 1 and/or operations 400 of FIG. 4.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of automated data extraction, comprising:
deploying a single visual question answering (VQA) model comprising a single neural network trained through a supervised learning process comprising:
receiving outputs from the single VQA model based on the single VQA model analyzing data that was generated by injecting respective text of a respective set of possible answers into given text and given positional data that was extracted from a given image; and
iteratively adjusting parameters of the single VQA model based on evaluating an objective function that compares the outputs from the single VQA model to known labels associated with the training inputs;
determining a question related to an image;
providing one or more inputs to the single VQA model based on the image and a set of possible answers associated with the question, wherein:
a data set is generated by injecting text of the set of possible answers into text and positional data extracted from the image; and
the single VQA model analyzes the data set and selects an answer from the set of possible answers based on the injecting of the text of the set of possible answers into the text and the positional data extracted from the image;
receiving, from the single VQA model in response to the one or more inputs, one or more outputs indicating the answer of the set of possible answers that was selected by the single VQA model; and
performing one or more actions within a software application based on the answer indicated in the one or more outputs.

2. The method of claim 1, wherein the text of the set of possible answers and the text data extracted from the image are analyzed by the single VQA model in a single forward pass.

3. The method of claim 2, wherein the single VQA model further analyzes the positional data extracted from the image during the single forward pass.

4. The method of claim 1, wherein the set of possible answers is not present in text form in the image.

5. The method of claim 4, further comprising:
determining a different question related to the image, wherein a given answer of a different set of possible answers associated with the different question is present in text form in the image;
providing one or more different inputs to the single VQA model based on the image; and
receiving, from the single VQA model in response to the one or more different inputs, one or more different outputs indicating the given answer of the different set of possible answers.

6. The method of claim 1, wherein performing the one or more actions within the software application based on the answer indicated in the one or more outputs comprises assigning a value to a variable in the software application based on the answer.

7. The method of claim 1, wherein performing the one or more actions within the software application based on the answer indicated in the one or more outputs comprises displaying the answer to a user via a user interface.

8. The method of claim 1, wherein the set of possible answers comprises true and false.

9. A method for training a model, comprising:
determining a set of possible answers to a question related to a plurality of images;
generating a training data set comprising:
training inputs that are based on the plurality of images and the set of possible answers; and
training outputs that are based on known answers to the question for the plurality of images; and
providing the training inputs to a single visual question answering (VQA) model, wherein:
a respective data set for each respective image of the plurality of images is generated by injecting text of the set of possible answers into text and positional data extracted from the respective image; and
the single VQA model analyzes, for each respective image of the plurality of images, the respective data set and selects an answer from the set of possible answers based on the injecting of the text of the set of possible answers into the text and the positional data extracted from the respective image;
receiving, from the single VQA model in response to the training inputs, outputs comprising the answer of the set of possible answers that was selected by the single VQA model for each respective image;
evaluating an objective function that compares the outputs to the training outputs; and
iteratively adjusting one or more parameters of the single VQA model based on the evaluating of the objective function.

10. The method of claim 9, wherein the text of the set of possible answers and the text data extracted from the respective image are analyzed by the single VQA model in a single forward pass.

11. The method of claim 10, wherein the single VQA model further analyzes the positional data extracted from the respective image during the single forward pass.

12. The method of claim 9, wherein the set of possible answers is not present in text form in the plurality of images.

13. A system, comprising:
one or more processors; and
a memory comprising instructions that, when executed by the one or more processors, cause the system to:
deploy a single visual question answering (VQA) model comprising a single neural network trained through a supervised learning process comprising:
receiving outputs from the single VQA model based on the single VQA model analyzing data that was generated by injecting respective text of a respective set of possible answers into given text and given positional data that was extracted from a given image; and
iteratively adjusting parameters of the single VQA model based on evaluating an objective function that compares the outputs from the single VQA model to known labels associated with the training inputs;
determine a question related to an image;
provide one or more inputs to the single VQA model based on the image and a set of possible answers associated with the question, wherein:
a data set is generated by injecting text of the set of possible answers into text and positional data extracted from the image; and
the single VQA model analyzes the data set and selects an answer from the set of possible answers based on the injecting of the text of the set of possible answers into the text and the positional data extracted from the image;
receive, from the single VQA model in response to the one or more inputs, one or more outputs indicating the answer of the set of possible answers that was selected by the single VQA model; and
perform one or more actions within a software application based on the answer indicated in the one or more outputs.

14. The system of claim 13, wherein the text of the set of possible answers and the text data extracted from the image are analyzed by the single VQA model in a single forward pass.

15. The system of claim 14, wherein the single VQA model further analyzes the positional data extracted from the image during the single forward pass.

16. The system of claim 13, wherein the set of possible answers is not present in text form in the image.

17. The system of claim 16, wherein the instructions, when executed by the one or more processors, further cause the system to:
determine a different question related to the image, wherein a given answer of a different set of possible answers associated with the different question is present in text form in the image;
provide one or more different inputs to the single VQA model based on the image; and
receive, from the single VQA model in response to the one or more different inputs, one or more different outputs indicating the given answer of the different set of possible answers.

18. The system of claim 13, wherein performing the one or more actions within the software application based on the answer indicated in the one or more outputs comprises assigning a value to a variable in the software application based on the answer.

19. The system of claim 13, wherein performing the one or more actions within the software application based on the answer indicated in the one or more outputs comprises displaying the answer to a user via a user interface.

20. The system of claim 13, wherein the set of possible answers comprises true and false.
